(19) United States
(12) Patent Application Publication
(10) Pub. No.: US 2025/0292383 A1
(43) Pub. Date: Sep. 18, 2025

(54) GRADING SYSTEM AND RELATED METHODS FOR GRADING COLLECTABLE ITEMS

(71) Applicant: Collectors Universe, Inc., Santa Ana, CA (US)

(72) Inventors: Kassim Lovett, Falls Church, VA (US); Danylo Prykhodko, Naples, FL (US); Pushkar Kumar Jain, Dallas, TX (US); Kenneth Tso, Little Neck, NY (US); David Shalamberidze, Naples, FL (US); Pratixa Joshi, Fremont, CA (US)

(73) Assignee: Collectors Universe, Inc., Santa Ana, CA (US)

(21) Appl. No.: 19/077,541

(22) Filed: Mar. 12, 2025

Related U.S. Application Data
(60) Provisional application No. 63/564,004, filed on Mar. 12, 2024.

(51) Int. Cl. G06T 7/00; G06Q 30/02; G06T 7/13; G06T 7/60

(52) U.S. Cl. CPC G06T 7/0002; G06Q 30/0278; G06T 7/13; G06T 7/60; G06T 2207/20081

(57) ABSTRACT

A grading system for using machine learning for grading a collectible item by reviewing different properties of the collectible item, such a card's centering properties. The grading system can include one or more computer devices to perform a process that includes receiving an image of the collectible item, using machine learning to determine, in the image, an outer box on an edge of the collectible item, and an inner box around a significant image printed on the collectible item or the image's inside border, and determining how well centered the image is on the collectible item based at least in part on comparing different reference distances against the card's edge.

### CROSS-REFERENCE TO RELATED APPLICATIONS

This application for a utility patent claims the benefit of U.S. Provisional Application No. 63/564,004, filed March 12. 2024.

### FIELD OF ART

The present disclosure is generally related to grading systems for grading collectible items, and more particularly to a grading system for using machine learning for determining the centering of an image on a collectible item, and related methods.

### SUMMARY

The invention includes a grading system for using machine learning for determining the centering of an image on a collectible item, among others. Collectible items can include sports cards, such as baseball cards and football cards, game cards, tickets, autograph cards, and trading cards, and Yu-Gi-Oh!® trading cards. The grading system comprises one or more computer devices having a computer processor and computer memory, the computer memory storing executable code that, when executed by the computer processor, enables the computer system to perform a process that comprises: receiving or processing an image of the collectible item; using machine learning to determine, in the image, an outer box on an edge of the collectible item, and an inner box around a significant image printed on the collectible item; and determining how well centered the image is on the collectible item. In some examples, the grading system is also trained to compute the image's centering properties without the presence of an inner box by keying in on recognizable indicia relative to the outer box.

### BRIEF DESCRIPTION OF THE DRAWINGS

These and other features and advantages of the present system and methods will become appreciated as the same becomes better understood with reference to the specification, claims and appended drawings.

FIG. 1 is a block diagram of one embodiment of a backend architecture that enables access to an inference service that embodies a grading system of the present invention.

FIG. 2 is a block diagram of one embodiment of the grading system of FIG. 1, wherein the grading system functions to utilize machine learning to generate pre-annotations which are then provided to an annotator for final annotations.

FIG. 3 is a block diagram of an annotation tool and machine learning tools utilized in the grading system of FIG. 2.

FIG. 4 is a plan view of an image of a trading card that includes a border, prior to annotation.

FIG. 5 is a plan view of the image of the trading card of FIG. 4, once the system has generated pre-annotations.

FIG. 6 is a plan view of an image of another trading card that does not include a border, once the system has generated pre-annotations.

### DETAILED DESCRIPTION

The detailed description set forth below in connection with the appended drawings is intended as a description of the presently preferred embodiments of a grading system equipped with machine learning for measuring centering properties, among other properties, of a collectible item provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

The system described herein may be implemented in a computer having a computer processor and a computer memory.

For purposes of this application, the terms “computer,” “computer device,” “server,” and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used.

The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The term “network” is defined to include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines, Digital Subscriber Lines (DSLs), wireless links including satellite links, or other communications links known to those skilled in the art. The network may further include any form of wireless network, including cellular systems, WLAN, Wireless Router (WR) mesh, or the like. Access technologies such as 3G, 4G, 5G, and future access networks may enable wide area coverage for mobile devices. In essence, the wireless network may include any wireless communication mechanism known in the art by which information may travel between computers of the present system.

The above-described drawing figures illustrate aspects of the invention, a grading system for grading collectible items, and more particularly to a system for using machine learning for determining the centering of an image on a collectible item, and related methods.

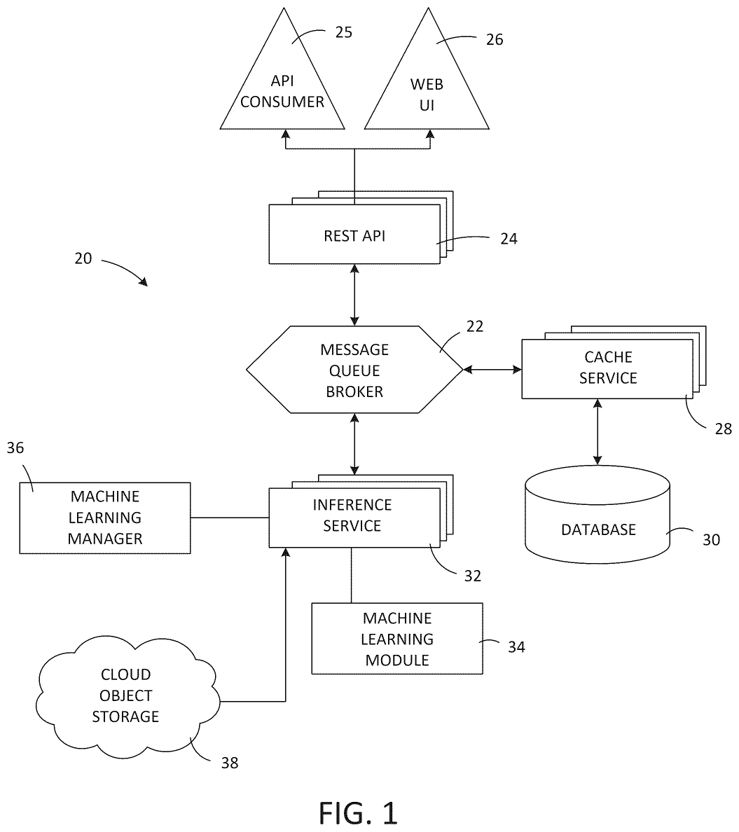

FIG. 1 is a block diagram of one embodiment of a machine learning backend architecture 20 that enables access to an inference service that embodies a grading system of the present invention. As shown in FIG. 1, the backend architecture 20 is based around a communication architecture such as a message queue broker 22, in this case an open source messaging system such as neural automatic transport service (“NATS”), although any form of message queue broker or equivalent system known in the art may be used. In this embodiment, the message queue broker 22 receives outside input via a REST API 24, which provides endpoints for direct interaction with the underlying system. The message queue broker 22 processes incoming requests and facilitates client-system communication. Requests and responses, in this embodiment, use JSON format, but other formats known in the art may be used to interact with consumer APIs 25, a web UI 26, and any other similar or equivalent systems. In this embodiment, NATS messaging is used for broadcasting notifications and receives results related to endpoint request activities.

The message queue broker 22 is also operably connected with a cache service 28 operably engaged with a database 30 that contains cached past predictions, so that the system can determine if the submission has already been received. The cache service avoids wasted computations and improves data access by maintaining cache past predictions. It fetches historical predictions from the database but also maintains a time-controlled in-memory cache for more requests. The expiration of in-memory cache items is adjustable via an environmental variable. The service updates the database to flag items requiring model predictions. NATS messaging is used for processing prediction requests and for updating the in-memory cache with real-time prediction data.

The message queue broker 22 is further operably connected with an inference system 32 that contains the machine learning model 34. This is discussed in greater detail below. The inference system 32 of this embodiment executes prediction tasks using a machine learning manager 36 in an isolated process, communicating with the parent service (e.g., via stdin, stdout, and stderr). The machine learning manager 36, such as MLFLOW, and utilizing cloud object storage 38, such as Amazon® S3, or any equivalent system. In this embodiment, the service interfaces with the machine learning lifecycle management server, MLFlow, to receive model metadata, state, and artifacts of historical and the active model.

Part of this MLFlow orchestration also involves the service interacting with the cloud object storage, which serves as a storage location for model artifacts. Instance 0 of the stateful set, acting as a conductor, synchronizes model state information from MLFlow to the local database. The database is also used as a centralized ledger of items from which this service reserves items awaiting model prediction. NATS messaging is used to disseminate prediction results and to also coordinate model change events across inference service instances.

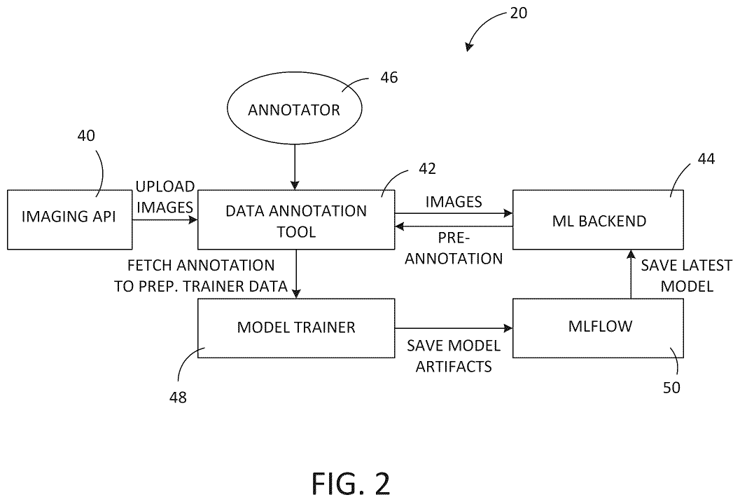

FIG. 2 is a block diagram of one embodiment of the grading system 20, in this case in the form of the inference system 32 of FIG. 1, wherein the system functions to utilize machine learning to generate pre-annotations which are then provided to an annotator 46 for final annotations. As shown in FIG. 2, the system 20 includes an imaging API 40 that may be used to receive an image of the collectible to be graded. The imaging API 40 directs the uploaded images to a data annotation tool 42 such as LabelStudio, although obviously any equivalent tool may be used. The data annotation tool 42 passes the image to the machine learning backend 44 (such as the inference system 32 of FIG. 1), which determines pre-annotations as discussed in greater detail below, and returns the pre-annotations to the data annotation tool 42. The ML backend 44 predicts boxes (or computes pre-annotations) on images. This enables an annotator 46 to just review and edit boxes previously generated by the ML backend rather than having to start from scratch.

In this embodiment, an annotator 46, typically a human with expertise in grading collectible items, particularly in centering and grading cards, reviews the image and either accepts or edits the pre-annotations. This information is sent to a model trainer 48 for improving the model, and the model artifacts are sent to the model manager 50, which is used to update the machine learning backend 44.

In another embodiment, however, the system may function without the annotator 46, if a purely automated process is desired. In this case, the system simply proceeds with the annotations generated by the ML backend 44.

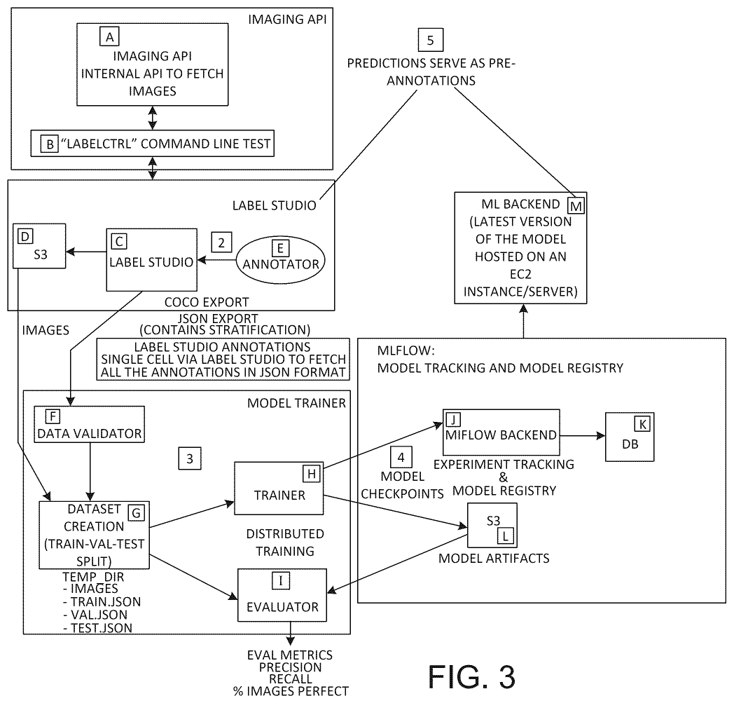

FIG. 3 is a block diagram of the inference system 32, showing more detail of an annotation tool and machine learning tools utilized in the grading system of FIG. 2. As shown in FIG. 3, the Imaging API is first used to fetch images as shown in step A. Step B is a “LABELCTRL” command line test. In step C, label studio (or an equivalent program) is operably connected with a cloud object storage (S3), and the annotator E is able to operably control the label studio. Annotations are send to data validator F of the model trainer, for dataset creation G, which is operably connected with trainer H and evaluator I. The model trainer interacts with MFLOW backend J of the model tracking and model registry.

In this embodiment, the model trainer is coded in Python, although obviously other languages may be used, and is used to train the centering model. The code base may be forked from Facebook's DeTR (Deformable transformers) model, although other models may be employed. The parameters have been tuned for centering use case of predicting tight fitting boxes. In this embodiment, the model manager 50, such as MLFlow or other known model registry, is used to help log experiments as well as stage models for production.

In use, the annotation tool and the machine learning tools of FIGS. 2-3 are used to receive the image of the collectible item, which is sent to the ML backend for pre-annotation based on previous training. Then the imaging API fetches image(s). Then the annotator person reviews the pre-annotation and uses the annotation tool, including using the label command line tool. Annotated images are exported to a data validator. Bounding boxes (pre-annotations) are stored in the S3 bucket, which is a data storage solution or mechanism in AWS with other cloud computing services contemplated. Data validator validates annotations that were sent by the annotator person (e.g., checks for mistakes and corrupted data). Then it converts the annotations from S3 into a dataset that is suitable for model training. A standard machine learning typically uses three sets: training, validation, and test sets. The datasets are sent to the trainer (centering model) for distributed training. The datasets are also sent to the evaluator (evaluates performance of trainer with low tolerance for error). Trainer<->MLFLOW (software that saves and manages trained model, logs experiments and stages models for production). MLFLOW stores large “artifacts of centering” in S3 bucket and communicates with database. Machine learning backend hosts the latest model from MLFLOW to provide pre-annotations for future data or for production.

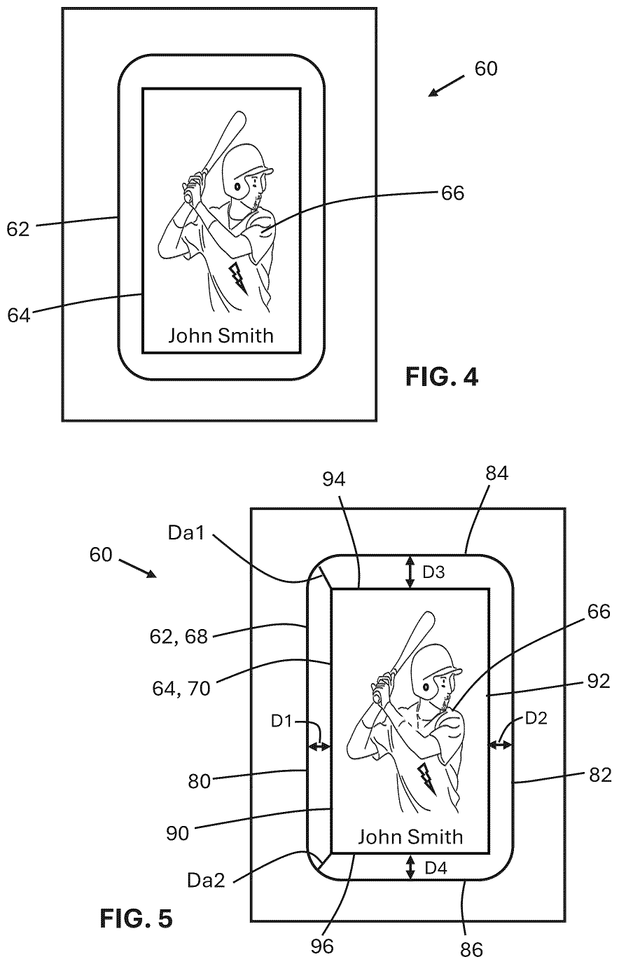

FIG. 4 is a plan view of an image 60 of a collectible card, which is shown as a baseball card but can embody any number of collectible cards, such as football cards and Yu-Gi-Oh!® trading cards, that includes an outer edge 62 and a border 64, prior to annotation. As shown in FIG. 4, a main image 66 is within the border 64.

FIG. 5 is a plan view of the image 60 of the trading card of FIG. 4, once the system has generated pre-annotations. In this embodiment, the pre-annotations include an outer box 68 (e.g., a card edge box) formed around the card edge 62, and an inner box 70 (e.g., a border edge box) formed around the border 64, as determined by the machine learning backend. From these boxes, distances (in this case, D1, D2, D3, and D4) may be calculated to determine if the image of the card is properly centered relative to reference lines or points on the card, as further discussed below.

In this embodiment, the system first determines, for the outer box 68, a first vertical wall 80, a second vertical wall 82, a first horizontal wall 84, and a second horizontal wall 86. Similarly, for the inner box 70, the system determines a first vertical wall 90, a second vertical wall 92, a first horizontal wall 94, and a second horizontal wall 96.

After defining the various reference lines or walls, a first distance D1 is measured between the first vertical wall 80 of the outer box 68 and the first vertical wall 90 of the inner box 70. A second distance D2 is measured between the second vertical wall 82 of the outer box 68 and the second vertical wall 92 of the inner box 70. A third distance D3 is measured between the first horizontal wall 84 of the outer box 68 and the first horizontal wall 94 of the inner box 70. A fourth distance D4 is measured between the second horizontal wall 86 of the outer box 68 and the second horizontal wall 96 of the inner box 70. The difference between the first and second distances D1 and D2 is calculated, and the difference between the third and fourth distances D3 and D4 is calculated. These values are then used to determine how well centered the image is of the collectible item based upon the calculated differences.

In an example, Hcen can represent the horizontal centering of the image 66 within the collectible card, computed by taking the absolute value of D1−D2, and Vcen can represent the vertical centering of the image 66 within the collectible card, computed by taking the absolute value of D3−D4. When Hcen is zero, then the image on the card is deemed to be centered horizontally relative to the outer box. When Vcen is zero, then the image on the card is deemed to be centered vertically relative to the outer box.

In an example, when Hcen decreases towards zero, the value of the collectible card increases and when Hcen increases above zero, the value of the collectible card decreases. In an example, when Vcen decreases towards zero, the value of the collectible card increases and when Vcen increases above zero, the value of the collectible card decreases. Thus, the value of a collectible card is inversely proportional to the values of Vcen and Hcen.

In an example, D1 is compared to D2 while D3 is compared to D4. In an example, the smaller the calculated differences are, in numerical values that represent distances, the more the image is considered centered. How centered an image is on the collectible card can be based on a distance difference in the vertical direction, a distance difference in the horizontal direction, or both. Distances D1 and D2 can be measured anywhere along the two vertical borders while distances D3 and D4 can be measured anywhere along the two horizontal borders. In one embodiment, the system may determine, using machine learning, the optimal points at which to make these measurements, and they may also be measured at different points (and averaged, or otherwise evaluated to determine the best points). A centering score can be provided by measuring D1 against D2 and D3 against D4, which can vary in scoring values based on a sliding scale of tolerances. In some examples, computer vision technology is trained to measure against “worst” points along the paired edges so that worse case centering scenarios can be determined. By evaluating “worse” case situations, the model can be effectively trained to look at borders 64 that are not squared relative to the card edges. For example, the border can be diamond shaped or rectangular shaped. This aspect of the invention is particularly advantageous as there are numerous variations in cards and the printing of cards is not always perfect.

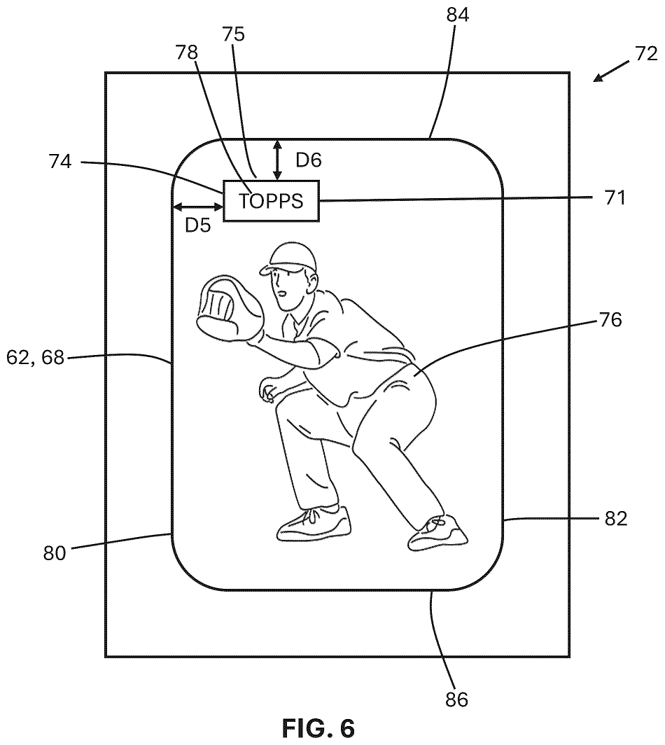

FIG. 6 is a plan view of an image of another collectible card that does not include a border, i.e., a borderless card image 72 with only a card edge 62. The card is shown with pre-annotations generated by the system. In this embodiment, without an internal border, a known indicia 78 is chosen for reference to measure or compare against the card edge. In this embodiment, the known indicia 78 on the card is used as a reference feature, which can be the card's logo. The system determines a bounding box or reference box 71 around the known indicia 78, which can include a vertical line 74 and a horizontal line 75, or two parallel vertical lines and two parallel horizontal lines, formed around the logo 78. The annotated logo box 71 can then be used as a border or a reference to compare the indicia against the card's edge 62. In other examples, other indicia on the image 72 may be chosen, such as a card description or a serial number, or any other indicia shown or printed on the card. In the present embodiment, the logo box 71 may be used to determine distances D5 and D6 from the card edge box 68. In an example, distance D5 is measured between the vertical line 74 of the reference box 71 and the first vertical wall 80 of the card's edge box 68 and distance D6 is measured between the horizontal line 75 of the reference box 71 and the first horizontal line 84 of the card's edge box. The system may compare these numbers to a standard, which may then be used to determine whether the image 76 is properly centered, or centered within specified values that correspond to a particular grade.

A collectible card may also contain less than a four-sided border. With reference again to FIG. 5 and assume the right border, i.e., the second vertical line 92, in which distance D2 is measured is missing, the system may also be trained to use other measurements to grade the card's centering properties. As shown, diagonal distances Da1 and Da2 may be used to add data points to allow the system to grade the card's centering properties. The diagonal measurements are particularly useful when the outer box has right angle or square corners instead of rounded corners as shown.

In some instances, borderless cards can have more than one logo, such as two or more logos. When desired logos are located on opposite sides of the cards, such as the top-left corner and the bottom-right corner, then it is possible to construct, annotate, or imagine an inner boundary encompassing the extreme edges of the two logos. In other words, edges of the two logos can be utilized to create an inner border located inwardly of the outer edges of the outer box of the card. Thus, when two or more logos are located as described, the system can be trained to analyze the card's centering as if the card has a border, e.g., a bordered card.

In another example, for a card with a 3-sided reference, the system can be trained to compute centering ratio based on distance between the decipherable edges of an inner boundary. For example, if the card has a 3-sided inner boundary, for example with the right-most edge of the inner boundary missing, then the machine learning module can be trained to measure centering ratio based on D3−D1 and D4−D1, as these particular dimensions are shown in FIG. 5.

In still other examples, the system is trained to learn new styles of cards as new card designs are circulated by card producers and manufacturers. For example, when a new card with a new style is circulated, the card with the new style can be annotated with borders and then trained to recognize the new style. Additionally, part of the machine learning can include getting feedback from human graders regarding other options, reference lines, points, text, or indicia that may be used for recognizing and computing the card's centering and then training the AI model with the feedback information.

Once the card's centering properties are determined using the system described herein, the centering properties, as determined by the machine learning system, are factored into a final grade for the collectible card being evaluated. In an example, the grading can be a numerical value ranging from 1 to 10, inclusive. The final grade can then be used by the owner of the card to offer in a sale transaction of the card. Alternatively, the final grade can be used to inform the owner of the collectible card about the card's monetary value. Still alternatively, once the card's centering properties are determined using the system described herein, the centering properties can be used as feedback for altering or changing the printing process to print future cards with improved centering properties. In still yet other examples, the card's centering properties as determined using the machine learning system described herein can be used as a bartering tool to negotiate monetary values, such as pricing, of the collectible cards associated with the centering properties.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

Methods of using the above-described system and components thereof are within the scope of the present invention.

Although limited embodiments of the system and their components have been specifically described and illustrated herein, many modifications and variations will be apparent to those skilled in the art. Furthermore, it is understood and contemplated that features specifically discussed for one embodiment may be adopted for inclusion with another embodiments, provided the functions are compatible. The disclosure is also defined in the following claims.

### Example Embodiments

The following are numbered example embodiments of methods, systems, and devices involving a grading system for grading a collectible item. The following examples, or any other examples disclosed herein, may be combined in whole or in part unless indicated otherwise. Elements of the examples disclosed herein, if applicable, are not limiting.

Example 1. In a first embodiment, the system is provided on one or more computer devices having a computer processor and computer memory, the computer memory storing executable code that, when executed by the computer processor, enables the computer system to perform a process of the present invention. In this example, the executable code performs the following steps: receiving an image of the collectible item; using a machine learning backend architecture to determine, in the image, an outer box on an edge of the collectible item, and an inner box around a significant image printed on the collectible item; and determining how well centered the image is on the collectible item by comparing distances between the outer box and the inner box. The centered information can be used as a factor to determine a monetary value of the collectible card.

Example 2. In a second embodiment, the determination of how well centered the image is on the collectible item is made by a human expert utilizing pre-annotations that are made by the machine learning backend architecture, the pre-annotations including the outer box and the inner box.

Example 3. In a third embodiment, the determination of how well centered the image is on the collectible item is made via a machine learning system utilizing the following steps: determining, for the inner box, a first vertical wall, a second vertical wall, a first horizontal wall, and a second horizontal wall; determining, for the outer box, a first vertical wall, a second vertical wall, a first horizontal wall, and a second horizontal wall; measuring a first distance between the first vertical wall of the outer box and the first vertical wall of the inner box; measuring a second distance between the second vertical wall of the outer box and the second vertical wall of the inner box; measuring a third distance between the first horizontal wall of the outer box and the first horizontal wall of the inner box; measuring a fourth distance between the second horizontal wall of the outer box and the second horizontal wall of the inner box; calculate the difference between the first and second distances; calculate the difference between the third and fourth distances; and determining how well centered the image is on the collectible item based upon the differences calculated. The centered information can be used as a factor to determine a monetary value of the collectible card.

Example 4. In a fourth embodiment, the machine learning backend architecture comprises: a message queue broker configured to receive outside input via a REST API, and process incoming requests; a cache service operably connected with the message queue broker and with a database that contains cached past predictions, so that the system can determine if the submission has already been received; and an inference system containing the machine learning model is operably connected with the message queue broker for executing prediction tasks using a machine learning manager.

Example 5. In a fifth embodiment, the machine learning backend architecture further comprises a machine learning manager and cloud object storage for receiving model metadata, state, and artifacts of historical and the active model.

Example 6. In a sixth embodiment, the invention includes a method of determining centeredness of a collectible card, the method comprising the steps of: receiving an image of the collectible card; using a machine learning backend architecture to determine, in the image, an outer box on an edge of the collectible item, and an inner box around a significant image printed on the collectible item; and determining how well centered the image is on the collectible item by comparing distances between the outer box and the inner box. The centered information can be used as a factor to determine a monetary value of the collectible card.

Example 7. A grading system for grading a collectible item, the grading system comprising: one or more computer devices having a computer processor and computer memory, the computer memory storing executable code that, when executed by the computer processor, enables the computer system to perform a process that comprises: receiving an image of the collectible item; using a machine learning backend architecture to determine, in the image, an outer box on an edge of the collectible item, and an inner box around a significant image printed on the collectible item; and determining how well centered the image is on the collectible item by comparing distances between the outer box and the collectible inner box. The centered information can be used as a factor to determine a monetary value of the collectible card.

Example 8. The assembly, system, device, apparatus, and method of any of the above Examples alone or in combination, wherein the determination of how well centered the image is on the collectible item is made by a human expert utilizing pre-annotations that are made by the machine learning backend architecture, the pre-annotations including the outer box and the inner box.

Example 9. The assembly, system, device, apparatus, and method of any of the above Examples alone or in combination, wherein the determination of how well centered the image is on the collectible item is made via the following steps: determining, for the inner box, a first vertical wall, a second vertical wall, a first horizontal wall, and a second horizontal wall; determining, for the outer box, a first vertical wall, a second vertical wall, a first horizontal wall, and a second horizontal wall; measuring a first distance between the first vertical wall of the outer box and the first vertical wall of the inner box; measuring a second distance between the second vertical wall of the outer box and the second vertical wall of the inner box; measuring a third distance between the first horizontal wall of the outer box and the first horizontal wall of the inner box; measuring a fourth distance between the second horizontal wall of the outer box and the second horizontal wall of the inner box; calculate the difference between the first and second distances; calculate the difference between the third and fourth distances; and determining how well centered the image is on the collectible item based upon the differences calculated.

Example 10. The assembly, system, device, apparatus, and method of any of the above Examples alone or in combination, wherein the machine learning backend architecture comprises: a message queue broker configured to receive outside input via a REST API, and process incoming requests; a cache service operably connected with the message queue broker and with a database that contains cached past predictions, so that the system can determine if the submission has already been received; and an inference system containing the machine learning model is operably connected with the message queue broker for executing prediction tasks using a machine learning manager.

Example 11. The assembly, system, device, apparatus, and method of any of the above Examples alone or in combination, wherein the machine learning backend architecture further comprises a machine learning manager and cloud object storage for receiving model metadata, state, and artifacts of historical and the active model.

Example 12. A method of determining centeredness of a collectible card, the method comprising the steps of: receiving an image of the collectible card; using a machine learning backend architecture to determine, in the image, an outer box on an edge of the collectible item, and an inner box around a significant image printed on the collectible item; and determining how well centered the image is on the collectible item by comparing distances between the outer box and the inner box.

Example 13. The assembly, system, device, apparatus, and method of any of the above Examples alone or in combination, further comprising the step of annotating the collectible card with two or more lines collectible on both the inner box and the outer box.

Example 14. The assembly, system, device, apparatus, and method of any of the above Examples alone or in combination, further comprising the steps of: using machine learning to determine, in the image, two or more distances along different points on the outer box and the inner boundary; and determining how well centered the image is on the collectible card by utilizing the two or more distances in an evaluation process.

Example 15. The assembly, system, device, apparatus, and method of any of the above Examples alone or in combination, wherein the machine learning is trained with feedback from a human grader be receiving from the human grader a first new distance measurement determined using the two or more lines annotated on the image of the collectible card.

Example 16. The assembly, system, device, apparatus, and method of any of the above Examples alone or in combination, wherein the determination of how well centered the image is on the collectible item is made via the following steps: determining, for the inner box, a first vertical wall, a second vertical wall, a first horizontal wall, and a second horizontal wall; determining, for the outer box, a first vertical wall, a second vertical wall, a first horizontal wall, and a second horizontal wall; measuring a first distance between the first vertical wall of the outer box and the first vertical wall of the inner box; measuring a second distance between the second vertical wall of the outer box and the second vertical wall of the inner box; measuring a third distance between the first horizontal wall of the outer box and the first horizontal wall of the inner box; measuring a fourth distance between the second horizontal wall of the outer box and the second horizontal wall of the inner box; calculate the difference between the first and second distances; calculate the difference between the third and fourth distances; and determining how well centered the image is on the collectible item based upon the differences calculated.

Example 17. A method of determining centeredness of a collectible card, the method comprising the steps of: receiving an image of the collectible card; providing a machine learning backend architecture that includes a message queue broker configured to receive outside input via a REST API, and process incoming requests; a cache service operably connected with the message queue broker and with a database that contains cached past predictions, so that the system can determine if the submission has already been received; and an inference system containing the machine learning model is operably connected with the message queue broker for executing prediction tasks using a machine learning manager; using the machine learning backend architecture to determine, in the image, an outer box on an edge of the collectible item, and an inner box around a significant image printed on the collectible item; and determining how well centered the image is on the collectible item by comparing distances between the outer box and the inner box.

Example 18. The assembly, system, device, apparatus, and method of any of the above Examples alone or in combination, further comprising the step of annotating the collectible card with two or more lines on both the inner box and the outer box.

Example 19. The assembly, system, device, apparatus, and method of any of the above Examples alone or in combination, further comprising the steps of: using machine learning to determine, in the image, two or more distances along different points on the outer box and the inner boundary; and determining how well centered the image is on the collectible card by utilizing the two or more distances in an evaluation process.

Example 20. The assembly, system, device, apparatus, and method of any of the above Examples alone or in combination, further comprising creating a bounding box around an indicia on a collectible card, the bounding box comprising at least a first vertical wall that is generally parallel to a first vertical wall on an outer box of the collectible card and at least a first horizontal wall that is generally parallel to a first horizontal wall on the outer box of the collectible card.

Example 21. The assembly, system, device, apparatus, and method of any of the above Examples alone or in combination, wherein the indicia is a logo, a serial number, or a card description of the collectible card.

Example 22. The assembly, system, device, apparatus, and method of any of the above Examples alone or in combination, wherein the collectible card is a trading card, a sports card, a Yu-Gi-Oh!® trading card, a game card, or a movie card.

Example 22. The assembly, system, device, apparatus, and method of any of the above Examples alone or in combination, wherein a collectible card is imaged, the imaged card is digitally annotated with an inner box inside a card's physical edge, and a digitally annotated with an outer box that coincides with the card's physical edge.

Example 22. The assembly, system, device, apparatus, and method of any of the above Examples alone or in combination, wherein the inner box coincides with the card's image border that is located inwardly of the card's physical edge.

Example 23. The assembly, system, device, apparatus, and method of any of the above Examples alone or in combination, wherein the machine learning module can be trained to measure centering ratio based on absolute values of D1−D2 and D3−D4, and wherein D1 is measured between a first vertical wall of the outer box and a first vertical wall of the inner box, D2 is measured between a second vertical wall of the outer box and a second vertical wall of the inner box, D3 is measured between a first horizontal wall of the outer box and a first horizontal wall of the inner box, and D4 is measured between a second horizontal wall of the outer box and a second horizontal wall of the inner box.

Example 23. The assembly, system, device, apparatus, and method of any of the above Examples alone or in combination, wherein Hcen=|D1−D2| and Vcen=|D3−D4|.

Example 24. The assembly, system, device, apparatus, and method of any of the above Examples alone or in combination, wherein the value of a collectible card is inversely proportional to the values of Vcen.

Example 25. The assembly, system, device, apparatus, and method of any of the above Examples alone or in combination, wherein the value of a collectible card is inversely proportional to the values of Hcen.

Example 26. The assembly, system, device, apparatus, and method of any of the above Examples alone or in combination, wherein the machine learning module can be trained to measure centering ratio based on absolute values of D3−D1 and D4−D1, and wherein D1 is measured between a first vertical wall of the outer box and a first vertical wall of the inner box, D3 is measured between a first horizontal wall of the outer box and a first horizontal wall of the inner box, and D4 is measured between a second horizontal wall of the outer box and a second horizontal wall of the inner box.

Example 27. The assembly, system, device, apparatus, and method of any of the above Examples alone or in combination, wherein centeredness of a card is based on an outer box that overlies the card's outer edge, and distances to the outer box's one or more vertical walls and one or more horizontal walls.

Example 28. The assembly, system, device, apparatus, and method of any of the above Examples alone or in combination, wherein two or more distance measurements of an indicia that is not the primary image on the collectible card and the one or more vertical walls and the one or more horizontal walls of the outer box are used to determine centeredness of the collectible card.

Example 29. The assembly, system, device, apparatus, and method of any of the above Examples alone or in combination, wherein the indicia at least one of a logo, a trademark, a brand, a name on the collectible card, a serial number, and a series label.

Example 30. The assembly, system, device, apparatus, and method of any of the above Examples alone or in combination, wherein the collectible card has no inner boundary.

Example 31. The assembly, system, device, apparatus, and method of any of the above Examples alone or in combination, wherein two or more diagonal distance measurements to two or more corners of the collectible card are used to determine the centeredness of the card.

What is claimed is:

1. A grading system for grading a collectible item, the grading system comprising:
one or more computer devices having a computer processor and computer memory, the computer memory storing executable code that, when executed by the computer processor, enables the computer system to perform a process that comprises:
receiving an image of the collectible item;
using a machine learning backend architecture to determine, in the image, an outer box on an edge of the collectible item, and an inner box around a significant image printed on the collectible item; and
determining how well centered the image is on the collectible item by comparing distances between the outer box and the collectible inner box.

2. The grading system of claim 1, wherein the determination of how well centered the image is on the collectible item is made by a human expert utilizing pre-annotations that are made by the machine learning backend architecture, the pre-annotations including the outer box and the inner box.

3. The grading system of claim 1, wherein the determination of how well centered the image is on the collectible item is made via the following steps:
determining, for the inner box, a first vertical wall, a second vertical wall, a first horizontal wall, and a second horizontal wall;
determining, for the outer box, a first vertical wall, a second vertical wall, a first horizontal wall, and a second horizontal wall;
measuring a first distance between the first vertical wall of the outer box and the first vertical wall of the inner box;
measuring a second distance between the second vertical wall of the outer box and the second vertical wall of the inner box;
measuring a third distance between the first horizontal wall of the outer box and the first horizontal wall of the inner box;
measuring a fourth distance between the second horizontal wall of the outer box and the second horizontal wall of the inner box;
calculate the difference between the first and second distances;
calculate the difference between the third and fourth distances; and
determining how well centered the image is on the collectible item based upon the differences calculated.

4. The grading system of claim 1, wherein the machine learning backend architecture comprises:
a message queue broker configured to receive outside input via a REST API, and process incoming requests;
a cache service operably connected with the message queue broker and with a database that contains cached past predictions, so that the system can determine if the submission has already been received; and
an inference system containing the machine learning model is operably connected with the message queue broker for executing prediction tasks using a machine learning manager.

5. The grading system of claim 4, wherein the machine learning backend architecture further comprises a machine learning manager and cloud object storage for receiving model metadata, state, and artifacts of historical and the active model.

6. A method of determining centeredness of a collectible card, the method comprising the steps of:
receiving an image of the collectible card;
using a machine learning backend architecture to determine, in the image, an outer box on an edge of the collectible item, and an inner box around a significant image printed on the collectible item; and
determining how well centered the image is on the collectible item by comparing distances between the outer box and the inner box.

7. The method of claim 6, further comprising the step of annotating the collectible card with two or more lines collectible on both the inner box and the outer box.

8. The method of claim 7, further comprising the steps of:
using machine learning to determine, in the image, two or more distances along different points on the outer box and the inner boundary; and
determining how well centered the image is on the collectible card by utilizing the two or more distances in an evaluation process.

9. The method of claim 7, wherein the machine learning is trained with feedback from a human grader be receiving from the human grader a first new distance measurement determined using the two or more lines annotated on the image of the collectible card.

10. The method of claim 6, wherein the determination of how well centered the image is on the collectible item is made via the following steps:
determining, for the inner box, a first vertical wall, a second vertical wall, a first horizontal wall, and a second horizontal wall;
determining, for the outer box, a first vertical wall, a second vertical wall, a first horizontal wall, and a second horizontal wall;
measuring a first distance between the first vertical wall of the outer box and the first vertical wall of the inner box;
measuring a second distance between the second vertical wall of the outer box and the second vertical wall of the inner box;
measuring a third distance between the first horizontal wall of the outer box and the first horizontal wall of the inner box;
measuring a fourth distance between the second horizontal wall of the outer box and the second horizontal wall of the inner box;
calculate the difference between the first and second distances;
calculate the difference between the third and fourth distances; and
determining how well centered the image is on the collectible item based upon the differences calculated.

11. A method of determining centeredness of a collectible card, the method comprising the steps of:
receiving an image of the collectible card;
providing a machine learning backend architecture that includes a message queue broker configured to receive outside input via a REST API, and process incoming requests; a cache service operably connected with the message queue broker and with a database that contains cached past predictions, so that the system can determine if the submission has already been received; and an inference system containing the machine learning model is operably connected with the message queue broker for executing prediction tasks using a machine learning manager;
using the machine learning backend architecture to determine, in the image, an outer box on an edge of the collectible item, and an inner box around a significant image printed on the collectible item; and
determining how well centered the image is on the collectible item by comparing distances between the outer box and the inner box.

12. The method of claim 11, further comprising the step of annotating the collectible card with two or more lines on both the inner box and the outer box.

13. The method of claim 12, further comprising the steps of:
using machine learning to determine, in the image, two or more distances along different points on the outer box and the inner boundary; and
determining how well centered the image is on the collectible card by utilizing the two or more distances in an evaluation process.

14. The method of claim 12, wherein the machine learning is trained with feedback from a human grader be receiving from the human grader a first new distance measurement determined using the two or more lines annotated on the image of the collectible card.
